(19) United States
(12) Patent Application Publication
(10) Pub. No.: US 2012/0235527 A1
(43) Pub. Date: Sep. 20, 2012

(54) Automated Power Generator

(75) Inventor: Tai Koan Lee, Mountain View, CA (US)

(73) Assignee: Tai Koan Lee, Mountain View, CA (US)

(21) Appl. No.: 13/049,930

(22) Filed: Mar. 17, 2011

(51) Int. Cl. H02K 21/00; H02N 11/00

(52) U.S. Cl. 310/152; 415/916

(57) ABSTRACT

One embodiment of an automated power generator has one base board (10), three magnet boards (48), two coil boards (58), driving boards (68), DC motor (70) with a set of transmission device including two pulleys (70A), (70B) and belt (70C), and a break (80). Base board (10), coil boards (58), fixed board (64) of driving boards (68) are mounted on four threaded rods (20), whereas magnet boards (48) and rotating board (62) of driving board (68) are mounted on shaft (30), Base board (10) is at the very bottom and driving boards (68) is at the top, with five total layers between them—two coil boards (58) sandwiched by three magnet boards (48). Other embodiments are described and shown.

### BACKGROUND

Mankind is facing two critical problems: the first is the depletion of gasoline arid the rising price of it and the second is the pollution caused by traditional energy resources, such as gasoline and coal. It is imperative to find other sources of energy.

### SUMMARY

In accordance with one embodiment an automated power generator comprises of a driving board, three magnet boards two coil boards, one closing board, and a break.

### Advantages

Accordingly several advantages of one or more aspects of an automated power generator are as follows: to provide an automated power generator that do not depend on any other energy resources, that can be easily made for large scales, that is not limited by location and connections to grid, that is easy to build and stable to use, and that does not bring any pollution to the environment. Other advantages of one or more aspects will be apparent from a consideration of the drawings and ensuing description.

### DRAWINGS—FIGURES

FIG. 1A is a perspective view of all essential parts assembled of an automated power generator in accordance with one embodiment.

FIG. 1B is an exploded view of the automated power generator shown in FIG. 1A in accordance with the first embodiment.

FIG. 1C is an enlarged perspective view of a magnet board of the automated power generator shown in FIG. 1A in accordance with the first embodiment.

FIG. 1D is an enlarged perspective view of a coil board of the automated power generator shown in FIG. 1A in accordance with the first embodiment.

FIG. 1E illustrates how coils in coil boards are connected in accordance with the first embodiment.

FIGS. 1F to 1K are various views of driving boards of the automated power generator shown in FIG. 1A in accordance with the first embodiment.

FIGS. 1L to 1R are various views of a break of the automated power generator shown in FIG. 1A in accordance with the first embodiment.

FIGS. 2A and 2B are perspective view and exploded view of an automated power generator in accordance with another embodiment without driving boards.

FIGS. 3A and 3B are perspective view and exploded view of an automated power generator in accordance with another embodiment with two sets of driving boards.

FIGS. 4A and 4B are perspective view and exploded view of an automated power generator in accordance with another embodiment with more magnet boards and coil boards than the first embodiment.

FIGS. 5A and 5B are perspective view and exploded view of an automated power generator in accordance with an embodiment with the main shaft installed horizontally and with magnet boards, coil boards and driving boards installed vertically.

FIGS. 6A and 6B are perspective view of a magnet board and a coil board that illustrates different ways to build magnet board and coil board.

### DRAWINGS—REFERENCE NUMERALS

10 Base Board or Cover Board

20 Threaded Rod

30 Main Shaft

42 Inner Circle of Magnets

42M1 Magnet Block on Inner Circle of Magnets

44 Outer Circle of Magnets

44MO Magnet Block on Outer Circle of Magnets

46 Gap Between Inner Circle of Magnets and Outer Circle of Magnets

48 48′ Magnet Board

52 Inner Circle of Coil grooves

54 Outer Circle of Coil grooves

52A˜52I Coils of Inner Circle

54A˜54I Coils of outer Circle

56 Gap Between Inner Circle and Outer Circle of Coil grooves

52U 52V 52W 52X 52Y 52Z Terminals of Coils of Inner Circle

54U 54V 54W 54X 54Y 54Z Terminals of Coils of Outer Circle

58 58′ Coil Board

62 Inner driving Board—Rotating

62MI Magnet fixed on Inner Driving Board

62G Gap in Between any Two Groups of Magnets Fixed on Inner driving Board

64 Outer Driving Board Fixed

64MO Magnet Fixed on outer Driving Board

68 Assembly of Driving Boards

70 Motor

70A 70B Pulleys

70C Belt

80 Break

80A One End of Break to be Rotatably Fixed onto a Threaded Rod

80B Another End of Break that can Clip onto a Threaded Rod

80P Break Plate

80M Magnet Fixed on Break Plate

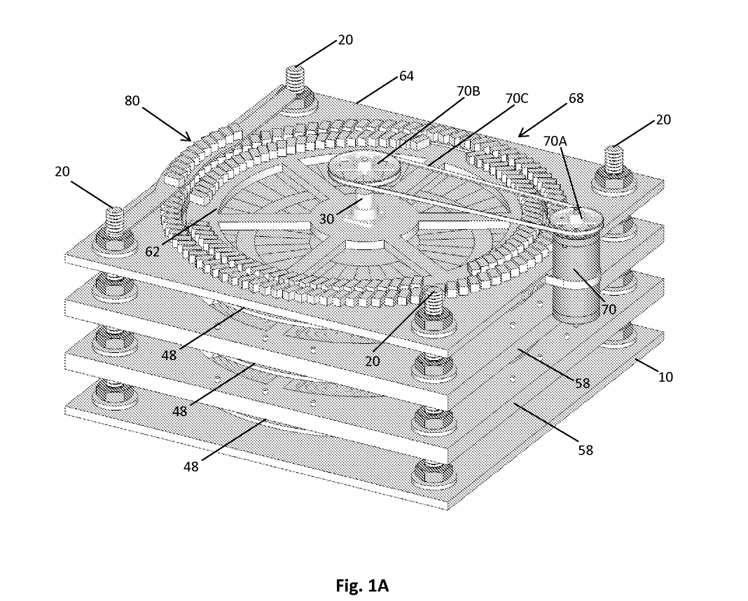

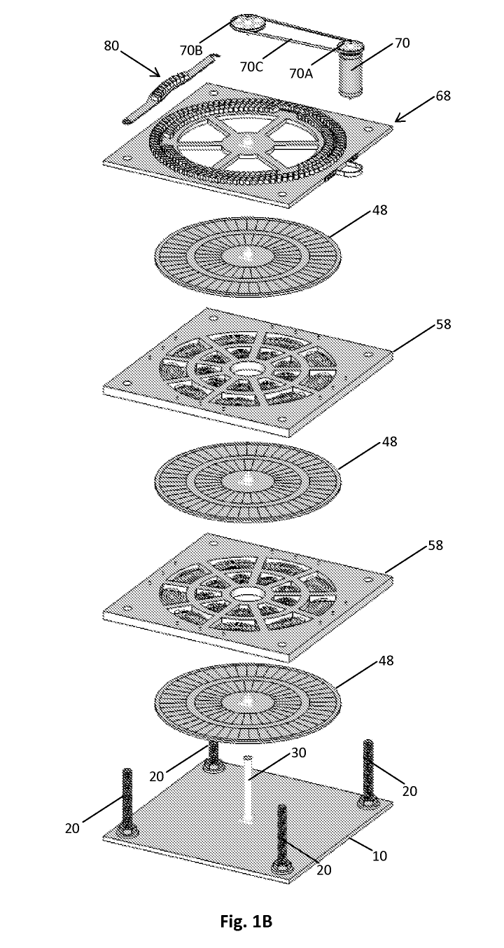

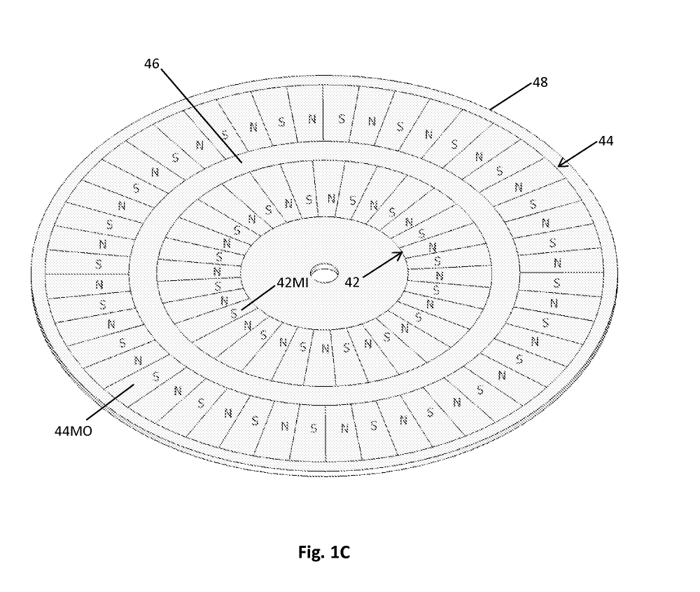

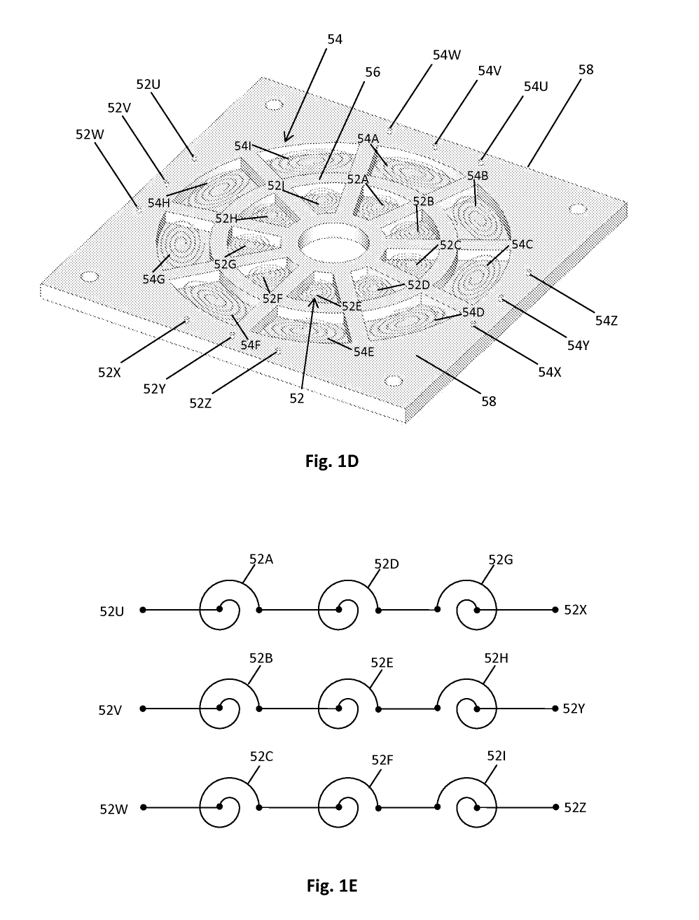

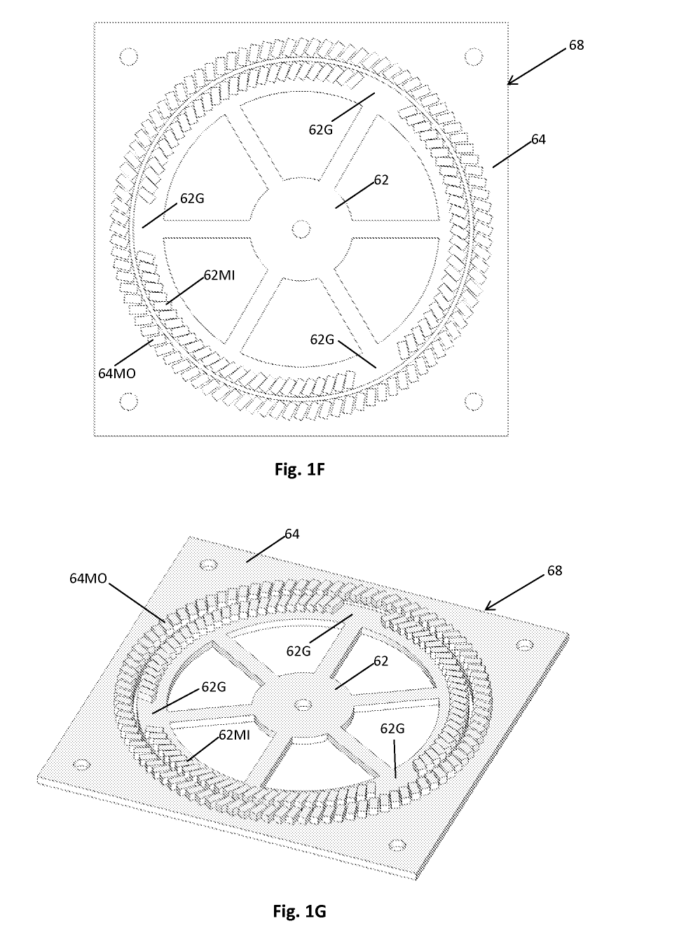

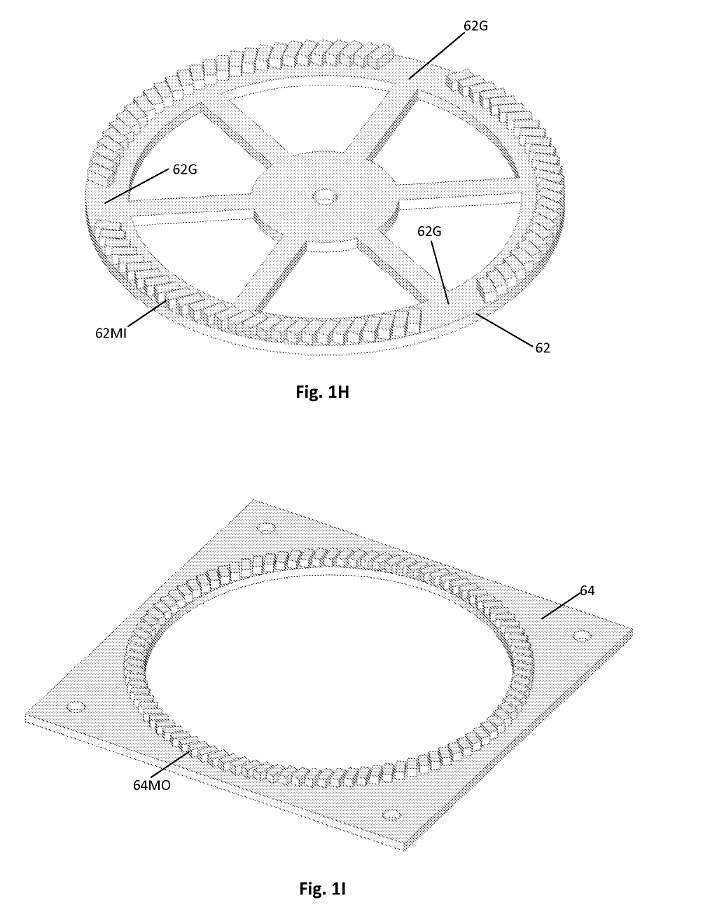

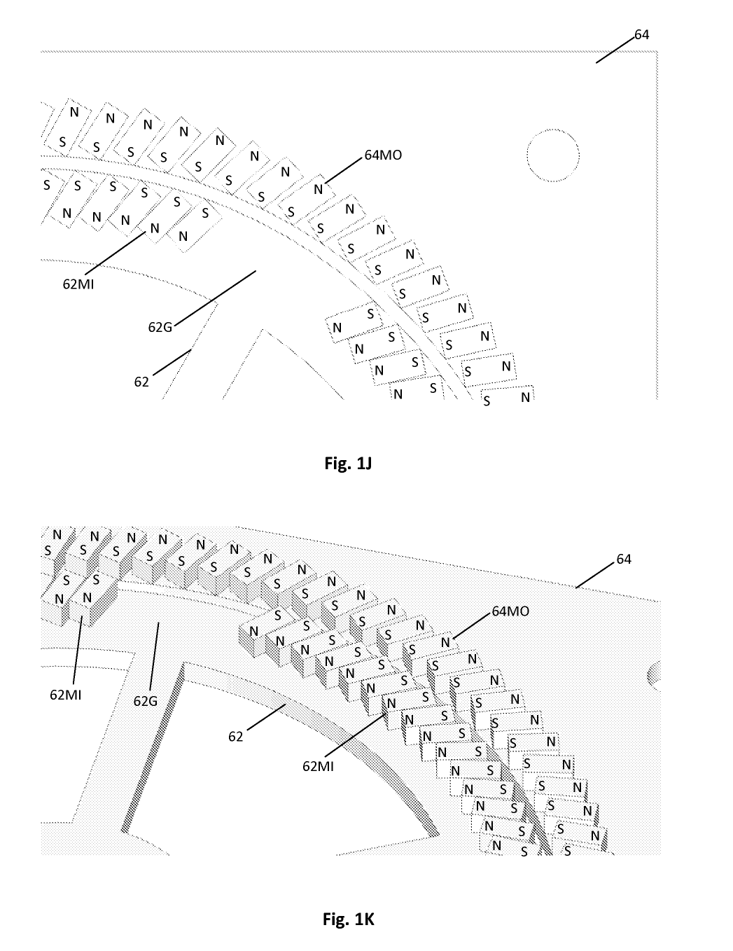

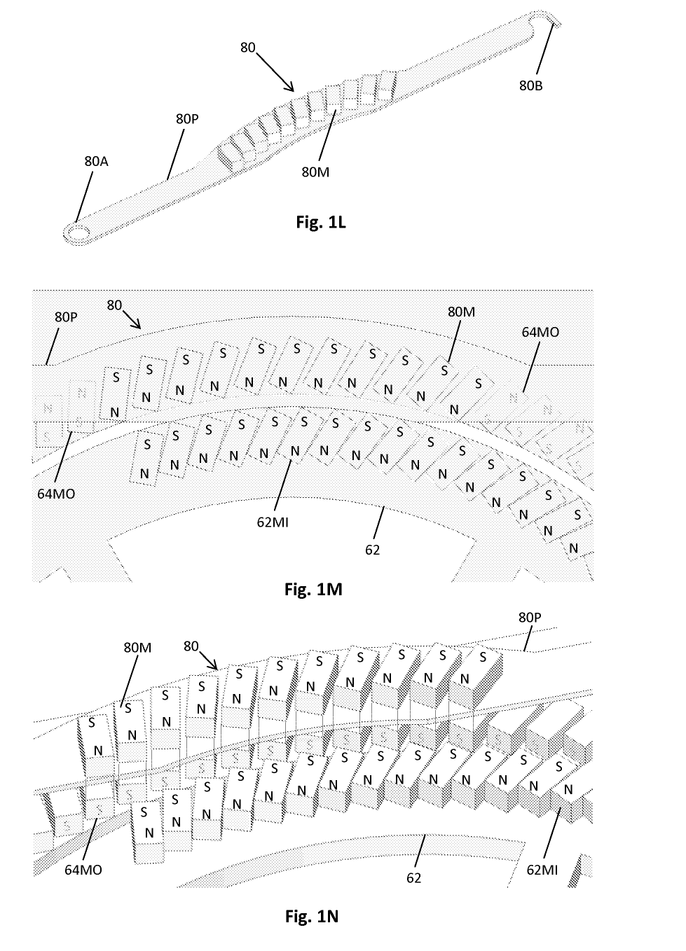

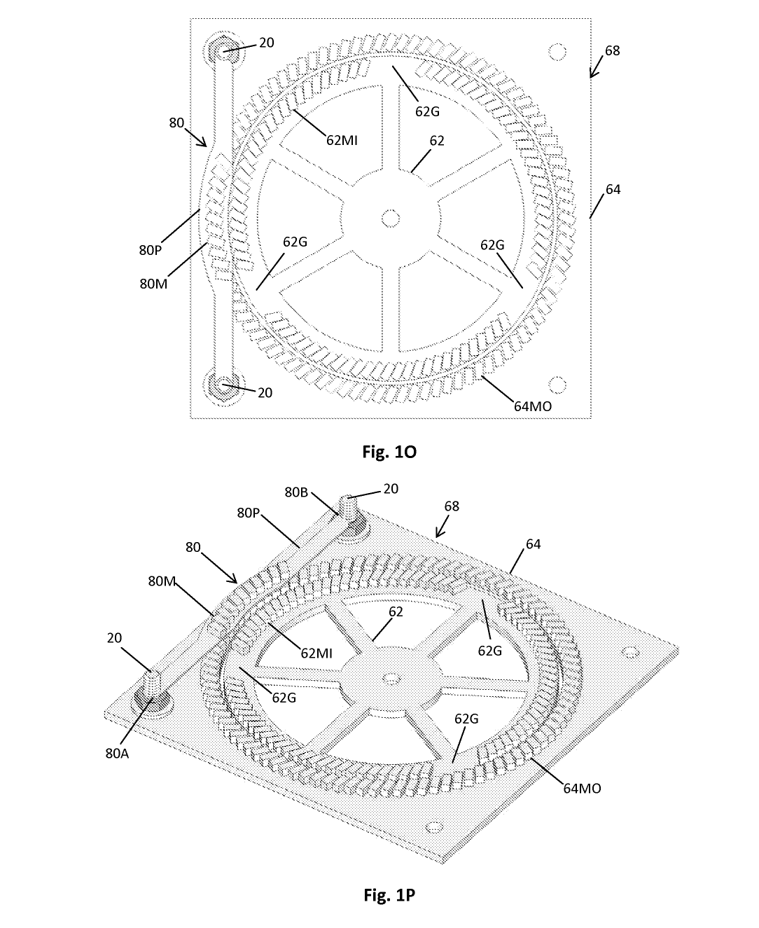

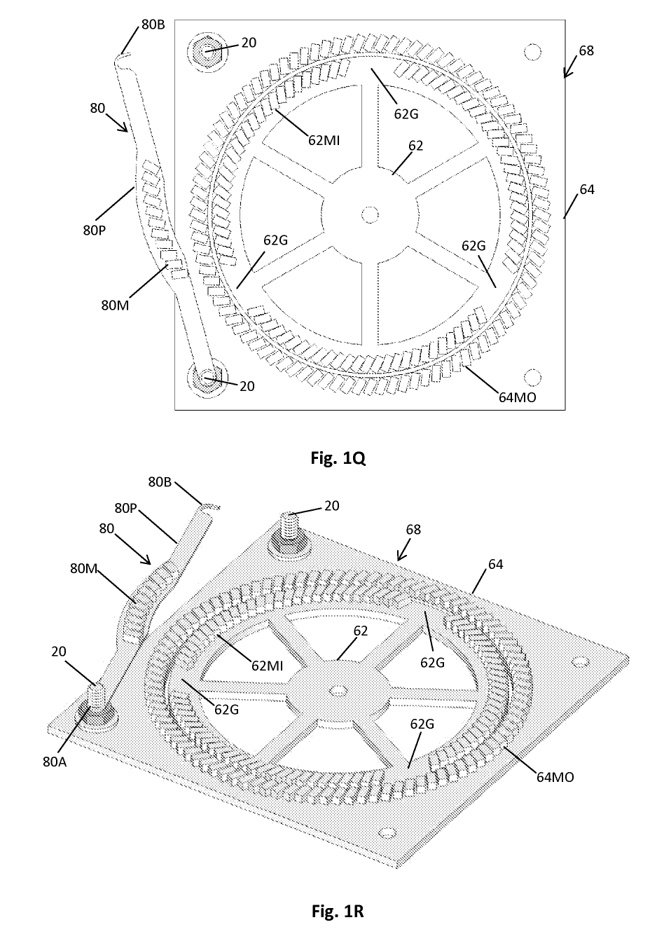

### Detailed Description—FIGS. 1A to 1R—First Embodiment

One embodiment of an automated power generator is illustrated in FIG. 1A (perspective view), FIG. 1B (Exploded view) and FIGS. 1C to 1R (various details).

I am going to first discuss the overall structure of this embodiment and then elaborate on each part of this embodiment.

As shown in FIGS. 1A and 1B, in this embodiment, the generator has a base board 10. At the four corners of base board 10, there are four fixed threaded rods 20. Shaft 30 is installed perpendicularly to base board 10 at its center point with one end attached to base board 10 and the other end extending upward.

On shaft 30, three magnet boards 48 and two coil boards 58 are arranged in an alternating fashion.

The first layer above base board 10 is a magnet board 48. All three magnet, boards 48 are fixed to shaft 30 such that magnet boards 48 rotate with the rotation of shaft 30.

Two coil boards 58 with the same horizontal dimension as base board 10 and a hole for shaft 30, are fixed on four threaded rods 20, arranged to be parallel and aligned to base board 10. Each coil board 58 has a hole in center area that allows shaft 30 to extend that freely.

Magnet boards 48 and coil boards 58 are installed in a way such that the distance between any two consecutive boards is minimized to the most while big enough to allow magnet boards 48 to rotate freely.

As the last layer on top of a magnet board 48, an outer driving board 64 is mounted on four threaded rods 20 with a big round hole in the middle. An inner board 62 is fixed onto shaft 30 such that when inner board 62 rotates shaft 30 follows to rotate. Inner board 62 is installed at the same level as outer board 64. Magnet blocks of outer board 64 (64MO) are arrayed on the inner edge of fixed outer board 64. Magnet blocks of inner board 62 (62MI) are arrayed on the outer edge of inner board 62. More details of how magnet blocks are arrayed on inner board 62 and outer board 64 will he elaborated later.

A direct current motor 70 is fixed at the edge of outer board 64. Pulley 70A is installed on the shaft of motor 70 and pulley 70B is installed on main shall 30. Pulleys 70A and 70B are connected by belt 70C such that when motor 70 rotates, shaft 30 follows to rotate.

A break 80 is installed on one of the four threaded rods 20 by one end while the other end is free to clip onto an adjacent threaded rod 20. Break 80 is installed right on top of the layer of driving board 68.

From this point on, I will elaborate on magnet board 48 (FIG. 1C), coil board 58 (FIGS. 1D˜1E), driving board 68 (FIGS. 1F˜1K), and break 80 (FIGS. 1L˜1R).

### First Embodiment: Magnet board 48—FIG. 1C

FIG. 1C shows a perspective view of magnet board 48. Magnet board 48 is a circular board, Aluminum or wood can be used to build magnet board 48. On top of magnet board 48, there are two circles of magnets 42 and 44.

Inner circle of magnets 42 has thirty-two fan-shaped magnets 42MI arrayed around the center point evenly with their N and S pole interlaced.

Outer circle of magnets 44 has forty-eight fan-shaped magnets 44MO arrayed along the outer circumference, evenly around the center point with their N and S pole interlaced.

Two circles of magnets 42 and 44 are separated by a gap 46.

### First Embodiment: Coil board 58—FIGS. 1D and 1E

FIG. 1D shows a perspective view of coil board 58. Coil board 58 can he a wood or aluminum board to hold coils. Coil board 58 has two sets of grooves organized as an inner circle 52 and an outer circle 54. Both circles 52 and 54 have nine evenly-cut fan-shaped grooves that contain coil 52A thru 52I and 54A thru 54I, respectively.

Circles of coil grooves 52 and 54 are separated by gap 56. The inner and outer radius of both circle 52 and 54 are the same as circles 42 and 44 of magnet board 48.

The nine coils on inner circle 52 are divided into three groups (52A, 52D, 52G), (52B, 52E, 52H), and (52C, 52F, 52I). Each coil is grouped with a coil two rolls away from itself so that when the centers of each coil is connected to the centers of the other two centers of the same group, a triangle forms where each tip is separated equidistantly from each other. In the same way, the nine coils on outer circle 54 are divided into three groups too: (54A, 54D, 54G), (54B, 54E, 54H), and (54C, 54F, 54I).

FIG. 1E is a simplified view showing how the three groups of rolls of coil on inner circle 52 are connected and how they are connected to outside terminals (52U, 52V, 52W) and (52X, 52Y, 52Z). For the simplicity of illustration and explanation, I rearranged the position of three groups of coils (52A, 52D, 52G), (52B, 52E, 52H) and (52C, 52F, 52I) in a linear fashion to its corresponding outside terminals, so that the connecting lines do not appear intricate. Also, the symbol of coil is simplified to clearly show the inside end and outside end, parts should only be identified by their names.

As FIG. 1E shows that in general, in each of the groups of coils, the outer end of first coil is connected to the inner end of second coil and the outer end of second coil is connected to the outer end of third coil, and then the set of coils is connected to two outside terminals, one on each end of the coil set, to form a linear circuit.

For instance, the coil set (52A, 52D, 52G) is connected as such: the outside end of coil 52A is connected to inside end of coil 52D and the outside end of coil 52D is connected to the outside end of coil 52G to form a linear connection between the coils, leaving the inside end of 52A and 52G open. These two open ends connect to outside terminals: inner end of 52A to outside terminal 52U and inner end of 52G to outside terminal 52X.

In the same way, the inside end of coil 52B is connected to outside terminal 52V while the outside end of coil 52B is connected to inside end of coil 52E. The outside end of coil 52E is connected to the outside end of coil 52H while the inside end of coil of 52H is connected to outside terminal 52Y.

Again, the inside end of coil 52C is connected to outside terminal 52W while the outside end of coil 52C is connected to the inside end of coil 52F. The outside end of coil 52F is connected to the outside end of coil 52I while the inside end of coil of 52I is connected to outside terminal 52Z.

The connection of coils for outer circle 54 is exactly the same as inner circle 52, as described below.

The outside end of coil 54A is connected to inside end of coil 54D and the outside end of coil 54D is connected to the outside end of coil 54G to form a linear connection between the coils, leaving the inside end of 54A and 54G open. These two open ends connect to outside terminals: inner end of 54A to outside terminal 54U and inner end of 54G to outside terminal 54X.

In the same way, the inside end of coil 54B is connected to outside terminal 54V while the outside end of coil 54B is connected to inside end of coil 54E. The outside end of coil 54E is connected to the outside end of coil 54H while the inside end of coil of 54H is connected to outside terminal 54Y.

Again, the inside end of coil 54C is connected to outside terminal 54W while the outside end of coil 54C is connected to the inside end of coil 54F. The outside end of coil 54F is connected to the outside end of coil 54I while the inside end of coil of 54I is connected to outside terminal 54Z.

During my experiment, I found the aforementioned way of connection is the frost efficient way. I tried all other combinations but none was as ideal as this one.

Different from common power generator, this embodiment has two circles of coils on each coil board which are connected to two sets of corresponding terminals. The output voltage and current from the two sets of terminals are different. Therefore, it is possible to connect each set of terminals to different appliances. It is also possible to use power output from one set of terminals to power up DC motor 70 through a transformer. That way, this embodiment becomes a self-sustained power generator.

### First Embodiment: Driving board 68—FIGS. 1F to 1K

FIGS. 1F and 1G are a top view and a perspective view of driving board 68, respectively. Driving board 68 is an assembly of two parts: a fixed board 64 and a rotating board 62.

Fixed board 64 is a square board with a big hole in the middle for rotating board 62. The center point of fixed board 64 lies where shaft 30 would stand. In this embodiment, the length of fixed board 64 is the same as the length of coil board 58. Fixed board 64 is mounted on the four threaded rods so that it is perpendicular to shaft 30.

Rotating board 62 is a round board that is mounted onto shaft 30 concentrically with the hole of fixed board 64. Fixed board 64 and rotating board 62 are installed at the same horizontal level. The difference between the radius of rotating board 62 and the radius of the round hole of fixed board 64 should be as small as possible and just big enough to let rotating board rotate freely around its center point.

To further assist with understanding the first embodiment, if fixed board 64 is a 48″ by 48″ square board with a hole of diameter 44″ in the middle, rotating board 62 has a diameter of 43″. The distance between the outer edge of rotating board 62 and the inner edge of fixed board 64 is half inch.

As shown in FIG. 1H, on the outer edge of rotating board 62, eighty-one rectangular magnets 62MI are separated by three gaps 62G into three groups of twenty-seven magnets. Each magnet 62MI is fixed so that its short side forms a 25 degree angle between itself and the tangential line of the outer circumference of rotating board 62. Each gap 62G is big enough to accommodate five consecutive magnet blocks 62MI. As such, if all three gaps 62G are filled with magnet blocks 62MI, there will be ninety-six magnet blocks 62MI evenly arrayed on the outer edge of rotating board 62.

As shown in FIG. 1I, along the inner edge of fixed board 64, there are ninety-six magnet blocks 64MO evenly arrayed so that its short side forms a 25 degree angle with the tangential line of the inner circumference of fixed board 64.

FIGS. 1J and 1K are enlarged top view and perspective view of part of driving boards 68 showing how magnet blocks 62MI and 64MO are arranged on rotating board 62 and fixed board 64, respectively. As we can see in FIG. 1J, S pole of magnet block 62MI and S pole of magnet block 64MO are facing each other across the seam between rotating board 62 and fixed board 64. It works the same way if one makes N pole of magnet blocks 62MI and N pole of magnet blocks 64MO face each other.

It is possible to glue magnet blocks 62MI and 64MO on top of rotating board 62 and fixed board 64, as illustrated in FIG. 1H and 1I. It is also possible to use two secured pieces of thin wood or aluminum boards to sandwich those magnets blocks to keep them in place.

It is most important to keep both rotating board 62 and fixed board 64 as light as possible and to keep the seam between the two boards as small as it can be to achieve higher RPM. The dimension of magnet blocks 64MO and 62MI I used are one inch by one inch by two inches. And the grade is N52. However, higher grade of magnet is desired to achieve better outcome. The size and amount of magnet blocks 62MI and 64MO can be adjusted to best match the size of rotating board 62 and fixed board 64.

### First Embodiment: Break 80—FIGS. 1L to 1R

FIG. 1L, is a perspective view of break 80. Break 80 consists of a base plate 80P and a set of magnet blocks 80M fixed on top of plate 80P. Break 80 has one end 80A which can be rotatably fixed to one of four threaded rods 20. Break 80 has another end 80B that can he clipped onto an adjacent threaded rod 20. When end 80B of base plate 80P clips onto threaded rod 20, break 80 is set to be on. When end 80B is taken off of threaded rod 20 and base plate 80P forms an angle of degree 15 or more from the edge of fixed board 64, break 80 is set to be off.

FIG. 1M and FIG. 1N shows the arrangement of magnet blocks 80M on top of base plate 80P. FIG. 1M is art enlarged X-Ray view from the top showing that when break 80 is set to be on, base plate 80P lies directly on top of magnet blocks 64MO on fixed driving board 64, thereby placing units of magnet blocks 80M directly over the units of magnet blocks 64MO. Magnet blocks 64MO 80M are identical in size and strength, and when break 80 is set to on, a unit of magnet block 64MO and 80M are in a same column. However, as shown in FIG. 1N, the north and south pole of magnet blocks 80M is set to be opposite of magnet blocks 64MO.

FIG. 1N shows that base plate 80P is parallel to fixed board 64 and the distance between base plate 80P and fixed board 64 is as small as possible while big enough to rotate base plate 80P around threaded. rod 20 freely.

FIGS. 1O and 1P are top and perspective view showing the position of break 80 when it is on.

FIGS. 1Q and 1R are top and perspective view showing the position of break 80 when it is off.

We can now summarize the first embodiment containing all parts discussed above, as described in FIGS. 1A and 1B: the first embodiment has one base board 10, three magnet boards 48, two coil boards 58, one driving board 68, and DC motor 70 with a set of transmission device including two pulleys 70A, 70B and belt 70C. Base board 10, coil boards 58, fixed board 64 of driving board 68 are mounted on four threaded rods 20, whereas magnet boards 48 and rotating board 62 of driving board 68 are mounted on shaft 30. Base board 10 is at the very bottom and driving boards 68 is at the top, with five total layers between them—two coil boards 58 sandwiched by three magnet boards 48.

Operation

When starting the generator, one first unclips end 80B of break 80 away from threaded rod 20 for at least 15 degree to set it to be off, and then initializes DC motor 70. Pulleys 70A, 70B and belt 70C collaboratively transmit the rotation motion from motor 70 to shaft 30.

When shaft 30 rotates, inner driving board 62 follows to rotate by the torque from shaft 60. Since the magnet blocks 62MI on the outer edge of board 62 and the magnet blocks 64MO on the inner edge of board 64 have same pole facing each other, repulsive force of magnets 62MI and 64MO on boards 62 and 64 magnifies the torque of main shaft 30 and contributes to rotary motion and increasing RPM.

Three gaps 62G among magnet blocks 62MI on rotating board 62 contribute to accelerate rotary motion of rotating board 62 in a short period of time. Without gaps 620, if the outer edge of rotating board 62 is filled with magnets 62MI evenly, it takes longer to accelerate rotary motion of rotating board 62.

When main shaft 30 rotates, it also drives three magnet boards 48 to rotate. When magnet boards 48 rotate, power is generated from coils 52A thru 52I on inner circle 52 and coils 54A thru 54I on outer circle 54 of coil boards 58.

The power generated from inner coil 52 can be used to keep motor 70 running while the power generated from outer circle 54 can be used to carry appliances or be transported to grid.

When stopping the generator, one first stops motor 70 and then clips the end 80B of break 80 to a threaded rod 20. As it is shown in FIG. 1N, N pole on magnet blocks 80M on break base plate 80 faces S pole on magnet blocks 64MO. Therefore, the pulling force between magnet blocks 80M and magnet blocks 64MO slows down and stops rotary motion of inner rotating board 62. This completes the shut down process of the generator.

### Alternative Embodiment

There are several different ways to build an automated power generator, by having different numbers of driving boards, different numbers of magnet boards and coil boards, as well as the orientation of assembly. I am going to introduce four alternative embodiments together with illustrations. I will also give some general discussion of different ways of embodiment without illustration at the end.

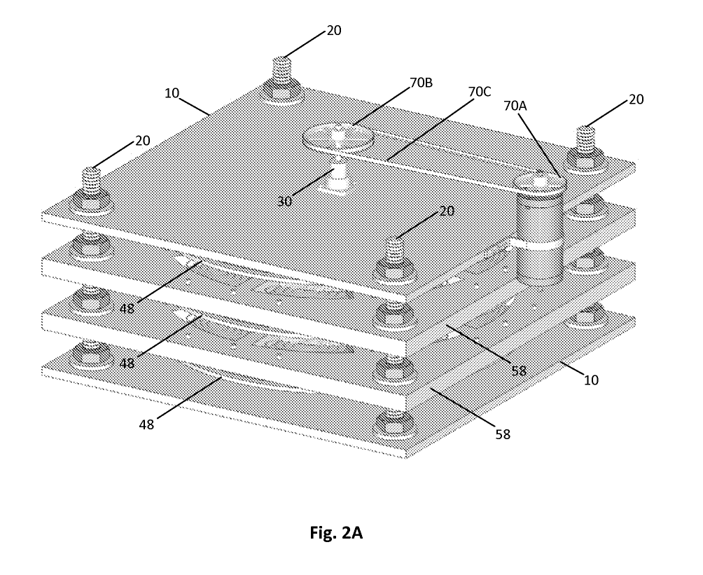

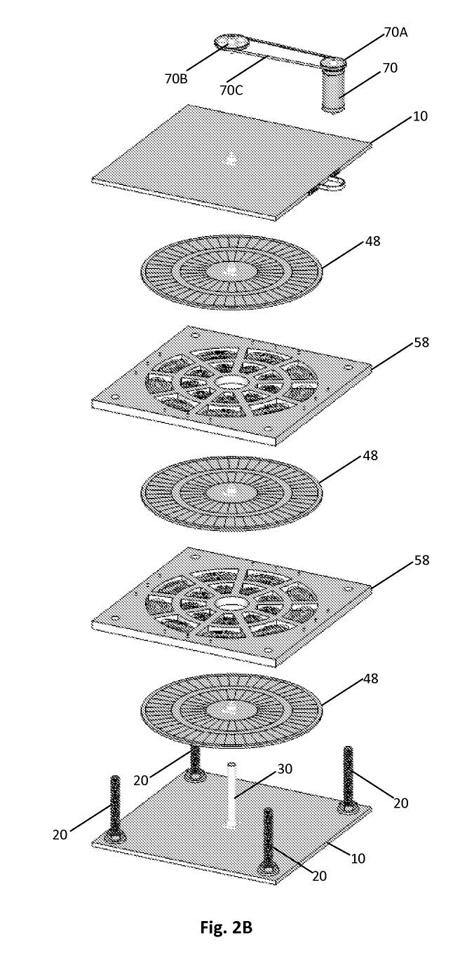

FIG. 2A and 2B are perspective view and exploded view of an alternative embodiment of automated power generator. This embodiment has almost the same elements as the first embodiment elaborated above except there is no driving board 68. Motor 70 directly drives shaft 30 to rotate by pulleys 70A, 70B and belt 70C. Since there is no driving board 58, the torque on shaft 30 generated by motor 70 cannot be magnified. Meanwhile, without a rotating board 52 full of heavy magnet blocks 52MI the load of motor 70 is relatively lighter. Therefore, it outputs electricity of high voltage when there is no power consumption. However, as soon as appliances that consume electricity are connected, the output power voltage drops significantly. After a short while, the output voltage becomes stabilized at a certain level.

In other words, with driving board 68 to magnify the torque on main shaft 30, the output power voltage is more stable regardless of power consumption; without driving board 68, the output power voltage changes more significantly when appliances are connected.

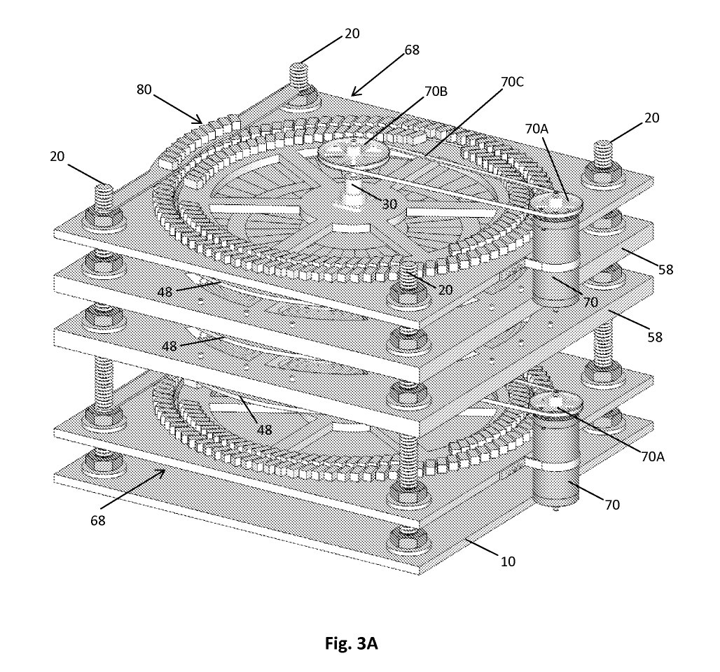

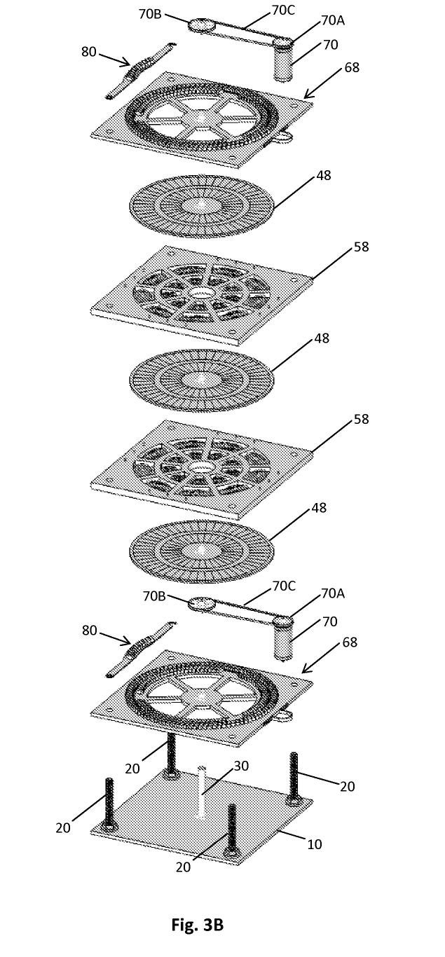

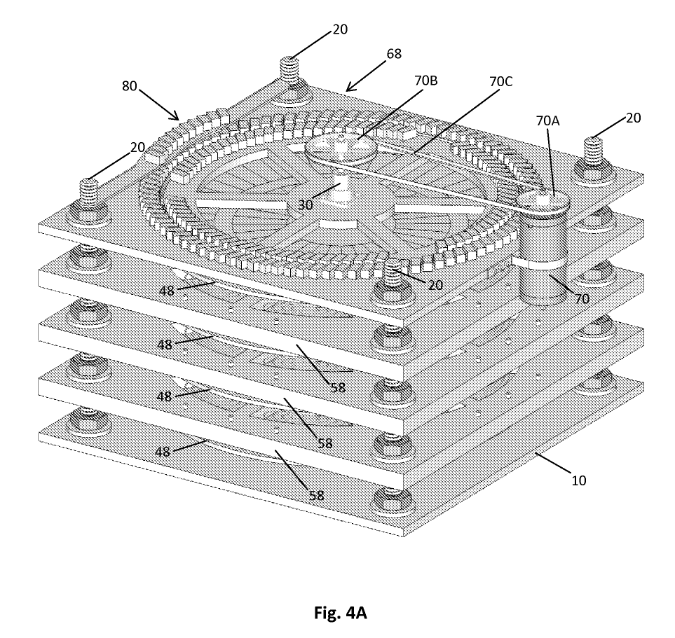

FIG. 3A and 3B are perspective view and exploded view of an embodiment with two driving boards 68 each with its own motor 70. It is also possible to use more motors for each driving board 68 to further magnify the torque on main shaft 30. The more driving boards 68 are used, the bigger torque is gained to speed up the rotation of magnet boards 48. One should choose an optimal combination by using the least number of driving boards and keeping the smallest size possible of driving boards while gaining the maximum rotation speed of magnet boards.

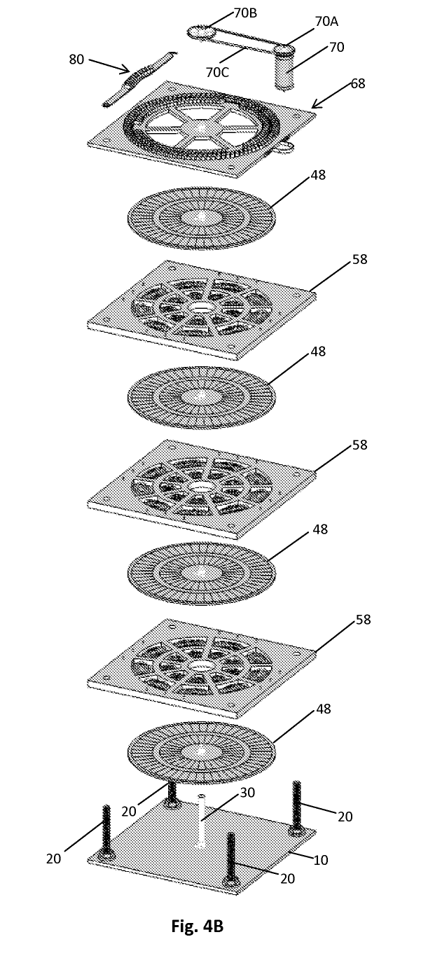

FIG. 4A and 4B are perspective view and exploded view of an embodiment with four coil boards and five magnet boards. More coil boards and magnet boards can be used to gain higher output of power.

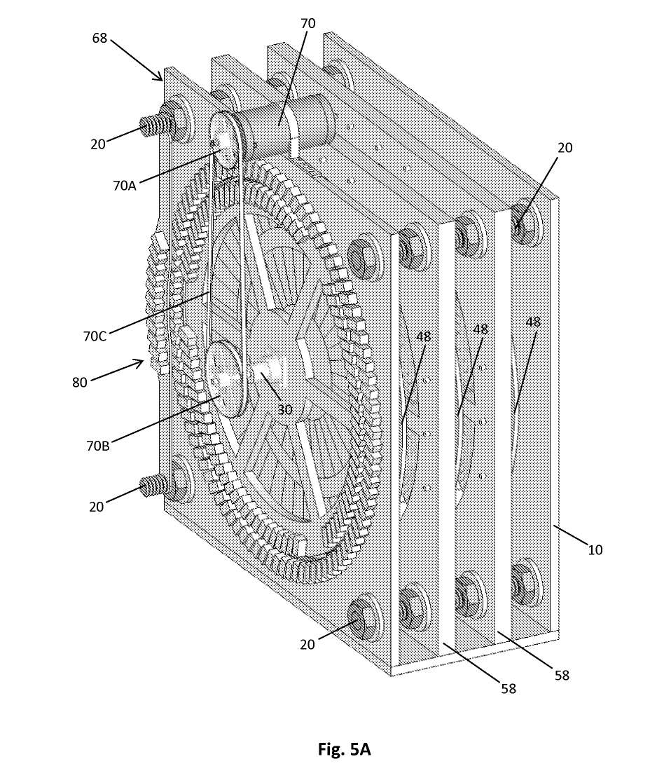

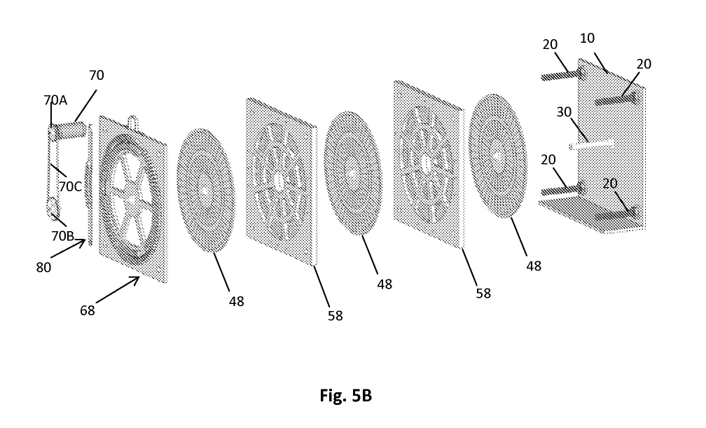

FIG. 5A and 5B are perspective view and exploded view of an embodiment that has exactly the same elements as the first embodiment where magnet board 48, coil boards 58, and driving boards 68 are all assembled vertically. The orientation of main shaft 30 is horizontal.

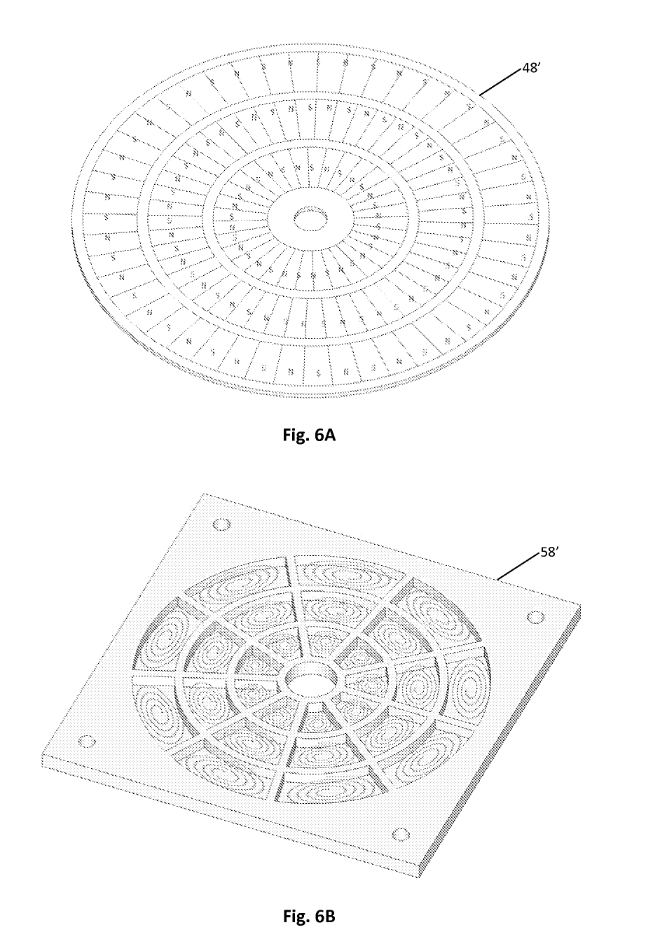

FIG. 6A and 6B show another way to build magnet board and coil board. Different from magnet board 48 shown in FIG. 1C, magnet board 48′ has three circles of magnets. Coil board 58′ has three circles of coils to he used as a pair with magnet board 48′. This way, electricity generated from each circle of coil can he output separately for different purposes, or to be combined for various voltage and current output.

There could be many other alternative embodiments. For example, the size of driving boards 68 can be larger than the size of coil boards 58, and the position of driving boards 68 can be in sandwiched by magnet boards 48 and coil boards 58 instead of being added as the last layer. Also, one can use bigger and stronger magnet blocks on the fixed board 64 of driving boards 68 to further magnify the torque of the main shaft 30. It is possible to have multiple circles of magnet on magnet boards 48 and multiple circles of coils on coil boards 58. Regarding gaps 62G in magnet blocks on inner rotating board 62, there can be varied number of gaps in the continuous circle of magnet blocks in inner rotating board 62 (three, five, seven, etc.).

### Advantages

From the description above, a number of advantages of sonic embodiments of my automated power generator become evident:
(a) This generator does not depend on other type of energy resources, such as gas or coal.
(b) It does not cause pollution.
(c) The amount of electricity generated is more than electricity consumed to operate the generator.
(d) It is easy to feed the electricity generated from the generator back to operate the generator so that it becomes a self-sustained system once initialized.
(e) It is cost efficient and easy to build and operate such a generator.
(f) Once initialized, it can operate 24 hours a day, independent of the weather.
(g) It does not require large space for operation.
(h) It is easily scalable.
(i) When a single part of the generator, for instance, one coil board or one magnet board, experiences a. problem, it is possible to take out only that part without affecting the entire generator's operation.

Conclusion, Ramification, and Scope

Accordingly, the reader will see that the automated power generator of the various embodiments does not consume other type of energy, does not cause pollution, is easy and straightforward to build and operate, and it is cost efficient and simple to maintain. In addition, it changes the concept of traditional power transmission. With the automated power generator setup locally, it is fairly easy to sustain the electricity of a building, a factory, or a school, and more without building expensive grid for power transmission. It could also save the cost of building power transmission system in a remote area or in a. Furthermore, this invention significantly reduces human dependency of natural energy resource such as gasoline or coal.

Although the description above contains much specificity, these should not be construed as limiting the scope of the embodiments but as merely providing illustrations of some of several embodiments. For example, this can include, but not limited to the coil board having more than three circles of coils.

Thus the scope of the embodiments should be determined by the appended claims and their legal equivalents, rather than by the examples given.

I claim:

1. An automated power generator comprising
a. a direct current motor,
b. a main shaft,
c. a transmission device,
d. one or a plurality of magnet boards,
e. one or a plurality of coil boards.

2. The power generator of claim I wherein said transmission device is a device for transmitting rotating motion from said direct current motor to said main shaft.

3. The power generator of claim 1 wherein said magnet board is a circular shaped board securely mounted on said main shaft perpendicularly at its center point to rotate after said main shaft.

4. The power generator of claim 3 therein said circular shaped board has magnet blocks arranged along one or a plurality of concentric circles separated by concentric circular gaps to it evenly around its center point with their north poles and south poles in an alternative fashion.

5. The power generator of claim 1 wherein said coil board has a central hole for said main shaft to extend thru freely.

6. The power generator of claim 5 wherein said coil board has one or a plurality of groups of nine coils arranged along one or a plurality of concentric circles separated by concentric circular gaps around said main shaft.

7. The power generator of claim 6 wherein each said circle of nine coils consist of three subgroups such that one coil is grouped with a coil two rolls away from itself.

8. The power generator of claim 7 wherein each said subgroups of three coils are connected such that the outer end of first coil is connected to the inner end of second coil and the outer end of second coil is connected to the outer end of third coil and then the set of coils is connected to two outside terminals, one on each end of the coil set, to form a linear circuit.

9. A driving device comprising of a fixed board, a rotating board, a main shaft, and sets of magnet blocks to magnify the torque of said main shaft.

10. The driving device of claim 9 wherein said fixed board is securely mounted horizontally or vertically and has an inner hole through whose center point said main shaft passes perpendicularly.

11. The driving device of claim 10 wherein a group of magnet blocks is arranged along the edge of said inner hole such that an imaginative line connecting north pole and south pole of each said magnet block are parallel to the surface of said fixed board and the pole surface of each said magnet block forms a predetermined degree angle between itself and the tangential line of the inner circumference with the same poles facing the center of said inner hole,

12. The driving device of claim 9 wherein said rotating board is a circular shaped board and securely mounted onto said main shaft perpendicularly at the same level as said fixed board to rotate after said main shaft.

13. The driving device of claim 12 wherein a group of magnet blocks is arranged along the edge of said rotating board such that an imaginative line connecting north pole and south pole of each said magnet block are parallel to the surface of said rotating board and each magnet block's pole surface forms a predetermined degree angle between itself and the tangential line of the outer circumference with the same poles facing the center of said rotating board.

14. The driving device of claim 13 wherein an odd number of gaps are arranged evenly among said group of magnet blocks on said rotating board to divide said group of magnet blocks into a plurality of equal subgroups.

15. An automated power generator comprising
a. a direct current motor,
b. a main shaft,
c. a transmission device,
d. one or a plurality of magnet boards,
e. one or a plurality of coil boards,
f. one or a plurality of sets of driving boards,
g. a break.

16. The power generator of claim 15 wherein said transmission device is a device for transmitting rotating motion from said direct current motor to said main shaft.

17. The power generator of claim 15 wherein said magnet board is a circular shaped board securely mounted on said main shaft perpendicularly at its center point to rotate after said main shaft.

18. The power generator of claim 17 wherein said circular shaped board has magnet blocks arranged along one or a plurality of concentric circles separated by concentric circular gaps to it evenly around its center point with their north poles and south poles in an alternative fashion.

19. The power generator of claim 15 wherein said coil board has a central hole for said main shaft to extend thru freely.

20. The power generator of claim 19 wherein said coil board has one or a plurality of groups of nine coils arranged along one or a plurality of concentric circles separated by concentric circular gaps around said main shaft.

21. The power generator of claim 20 wherein each said circle of nine coils consist of three subgroups such that one coil is grouped with a coil two rolls away from itself.

22. The power generator of claim 21 wherein each said subgroups of three coils are connected such that the outer end of first coil is connected to the inner end of second coil and the outer end of second coil is connected to the outer end of third coil and then the set of coils is connected to two outside terminals, one on each end of the coil set, to form a linear circuit.

23. The power generator of claim 15 wherein said set of driving boards comprising of a fixed board and a rotating board.

24. The power generator of claim 23 wherein said fixed board is securely mounted and has an inner hole through whose center point said main shaft passes perpendicularly.

25. The power generator of claim 24 wherein a group of magnet blocks is arranged along the edge of said inner hole such that an imaginative line connecting north pole and south pole of each said magnet block are parallel to the surface of said fixed board and the pole surface of each said magnet block forms a predetermined degree angle between itself and the tangential line of the inner circumference with the same poles facing the center of said inner hole.

26. The power generator of claim 23 wherein said rotating board is a circular shaped board and securely mounted onto said main shaft perpendicularly at the same level as said fixed board to rotate after said main shaft.

27. The power generator of claim 26 wherein a group of magnet blocks is arranged along the edge of said rotating board such that an imaginative line connecting north pole and south pole of each said magnet block is parallel to the surface of said rotating board and each said magnet block's pole surface forms a predetermined degree angle between itself and the tangential line of the outer circumference with the same poles facing the center of said rotating board.

28. The power generator of claim 27 wherein an odd number of gaps are arranged evenly among said group of magnet blocks on said rotating board to divide said group of magnet blocks into a plurality of equal subgroups.

29. The power generator of claim 15 wherein said break is a means for holding a plurality of magnet blocks such that an imaginative line connecting north pole and south pole of each said magnet block is parallel to the surface of said rotating board and said means for holding said magnet blocks can be moved away or close to overlap horizontally or vertically upon said magnet blocks on said fixed board of claim 24.

30. The power generator of claim 29 wherein north and south poles of said plurality of magnet blocks of said break are laid out the same way as said magnet blocks of said rotating board to hold said rotating board stable by pulling force between the opposite pole of said magnet blocks of said break and said magnet blocks of said rotating board.
